(19) United States
(12) Patent Application Publication
(10) Pub. No.: US 2006/0046030 A1
(43) Pub. Date: Mar. 2, 2006

(54) Electrophotographic transfer sheet

(75) Inventor: Yuichi Shiba, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: MITSUBISHI PAPER MILLS LIMITED, Tokyo (JP)

(21) Appl. No.: 10/526,478

(22) PCT Filed: Dec. 25, 2002
(86) PCT No.: PCT/JP02/13553

§ 371 Date: Mar. 4, 2005

(30) Foreign Application Priority Data
Sep. 27, 2002 (JP) 2002-282249
Dec. 19, 2002 (JP) 2002-368559
Dec. 19, 2002 (JP) 2002-368560

(51) Int. Cl. B41M 5/00

(52) U.S. Cl. 428/195.1

(57) ABSTRACT

The present invention provides a transfer paper for electrophotography which can be printed by electrophotographic printers, facsimile, copiers and on-demand printers, has excellent toner fixability and is excellent in gloss of printed images, and can produce images close to those formed on photographic papers in gloss of white paper and gloss of printed image portions. The present invention relates to a transfer paper for electrophotography comprising a base paper and at least one coating layer provided thereon, characterized in that the uppermost coating layer contains not less than 5 parts by mass of an organic hollow pigment in 100 parts by mass of pigment.

### TECHNICAL FIELD

The present invention relates to a transfer paper for electrophotography. More particularly, it relates to a transfer paper for electrophotography which can be printed by electrophotographic printers, facsimile, copiers and on-demand printers, has excellent toner fixability, is excellent in gloss of images after printing, and can provide images close to those formed on photographic papers in gloss of white papers and gloss of image portions after printing.

### BACKGROUND ART

Outputting by electrophotographic processes has rapidly spread due to expansion of on-demand printing and printing from personal computers.

Hitherto, sublimation type thermal transfer systems have preceded as high-quality output media and have been employed in the field of image processing in medical practice, but have suffered from serious problems that they are expensive and require a long time for printing.

With recent remarkable improvement of resolution and improvement of technology for fining ink drops, ink jet printing can produce images having quality close to photographic image quality, and some photo systems become commercially available owing to their low running cost. However, the problem has not yet been solved that the ink jet printing requires a long time for printing though it is inexpensive.

The electrophotographic processes which are relatively inexpensive and require a short printing time are noticed not only for output of mainly texts, but also for full color output which regards visuals as important. According to the electrophotographic processes, a latent image of an original is formed on a semiconductor material and made visible with a toner, and this toner image is transferred onto an image receiving material. The toner is fixed on the image receiving material generally by heat.

Hitherto, a high glossy paper is sometimes used as the image receiving material, but it has a problem that the image made of toner becomes matte. Furthermore, in case a thick paper is used for high-speed printing or for obtaining a texture of photographs, fixability of toners is inferior and the images may fall off upon rubbing, and hence a sufficient heating time must be taken by decreasing the heating speed. Thus, a transfer paper improved in gloss of the image portions and excellent in fixability of toners has been demanded.

Moreover, an image receiving material for electrophotographic processes is disclosed in which the receiving layer contains a water-soluble polyester resin and/or a water-dispersible polyester resin and is formed by cast-coating. The polyester resin is used for improving paper gloss to reduce the difference in gloss between a thick toner area and a thin toner area or for recycling the raw materials for the polyester resin, and not for the purpose of improving gloss of the image portions of solid prints or fixability of toners (e.g., JP-A-2000-305305).

Furthermore, there is a disclosure of a coated paper as a transfer paper for electrophotography in which a coating color containing a synthetic silica having a given specific surface area is coated on the uppermost layer of recording layer by cast-coating method. However, this coated paper is for inhibition of blistering caused by improvement of gas permeability and for improvement of gloss of images in the half tone portion by giving a relatively high white paper gloss of 50% or higher, and is insufficient as a transfer paper improved in gloss of all image portions including solid print portions and improved also in toner fixability (e.g., Japanese Patent No. 2736943).

There is a further disclosure of a transfer paper for electrophotography or thermal transfer in which the void structure of transfer layer is measured by a mercury penetration type porosimeter and the uppermost layer of the transfer layer is provided by casting method. However, this transfer paper aims at improving the absorption rate of molten toner or ink and cannot directly contribute to efficient melting of toners required for printing at high speed or printing on thick papers (e.g., JP-A-7-98510).

Moreover, there are disclosures of a transfer sheet for both the heat sensitive recording and the electrophotography which is provided with a heat insulating layer containing voids and a copying method using the transfer sheet, but the disclosures concern mainly with a technology of designing a heat sensitive recording layer which does not result in color formation with the heat generated at the fixing mechanism in the electrophotographic recording method and the heat insulating layer is provided for the purpose of improving printability with thermal head of thermal printers. Thus, this technology does not aim at improvement of paper gloss by cast finishing or improvement of electrophotographic suitability such as toner fixability or gloss of image portions (e.g., JP-A-2001-63215).

Moreover, a transfer paper for electrophotography is disclosed in which the relation between basis weight and density of the paper is determined by a certain formula and besides the thermal conductivity in steady thermal conductivity method is set at lower than a certain value, and this technology merely empirically shows the physical properties of a paper usable without causing failure in fixing of toners in a specific printing machine and makes no mention of a method for positive solution of various problems and demands on gloss and fixability of toners in the image portion other than the physical properties of conventional transfer papers for electrophotography (e.g., JP-A-2000-321808).

### DISCLOSURE OF INVENTION

The object of the present invention is to provide a transfer paper for electrophotography which can be printed by electrophotographic printers, facsimile, copiers and on-demand printers, has excellent fixability of toners, is excellent in gloss of printed images, and can provide images close to those formed on photographic papers in gloss of white papers and gloss of printed image portions.

The inventors have conducted an intensive research and accomplished the transfer paper for electrophotography of the present invention.

That is, the transfer paper for electrophotography of the first invention is a transfer paper comprising a base paper and at least one coating layer provided thereon, characterized in that the uppermost coating layer contains not less than 5 parts by mass of an organic hollow pigment based on 100 parts by mass of pigment in the uppermost coating layer.

The transfer paper for electrophotography of the second invention is characterized in that it comprises a support comprising a base paper coated on both sides with a resin having film-forming ability and at least one coating layer provided on the side of the support corresponding to the side to be printed, and the uppermost coating layer contains not less than 5 parts by mass of an organic hollow pigment based on 100 parts by mass of pigment in the uppermost coating layer.

The transfer paper for electrophotography of the third invention is a transfer paper comprising a base paper and at least one coating layer provided thereon, characterized in that the uppermost coating layer contains not less than 5 parts by mass of an organic hollow pigment based on 100 parts by mass of pigment in the uppermost coating layer and the coating layer has a gloss given by casting treatment.

In the third invention, it is preferred that the transfer paper has a paper gloss of 80% or more in terms of 75° specular gloss measured in accordance with JIS P-8142.

In the above invention, the transfer paper is characterized in that the organic hollow pigment has a percentage of hollowness of not less than 30% and has a particle diameter of not less than 300 nm.

In the above invention, it is preferred that the transfer paper has a basis weight of not less than 140 g/m².

### BEST MODE FOR CARRYING OUT THE INVENTION

The transfer paper for electrophotography of the present invention will be explained in detail below.

First of all, it is not clear why the fixability of toners and image gloss are improved by using an organic hollow pigment in the uppermost coating layer, but it is considered that this is because the hollow organic pigment is smaller in specific gravity than kaolin clays used as general coating pigments and has voids filled with air and, hence, causes increase of heat insulation of the coating layer when it is used as a coating pigment and furthermore improves cushioning properties under heating. Owing to the increase of heat insulation, heating for fixation of toners is efficiently focused to toners and thus fixability will be improved. Furthermore, due to the improvement of cushioning properties, heating efficiency and adhesion in cast treatment are improved and the paper gloss becomes higher and the whole image gloss including half tone is improved.

Fixation of toners onto the transfer paper is carried out by moderate melting or softening of toners by heating. When the transfer paper is thick, the heating time is short, the heating temperature is low, and toners, transfer papers and machines are under low temperatures because of low temperature of printing environment, the temperature of toners per se does not sufficiently rise, and, as a result, the melting or softening of toners is insufficient to cause troubles such as deposition of toners on transferring members, deterioration of gloss of the printed portions, reduction of print density, exfoliation of the printed portions and reduction of resistance to rubbing. These technical problems hinder speeding-up of printing machines, saving of energy, utilization of thick transfer papers and use of printing machines in cold environment. However, by using, in a coating layer, an organic hollow particle, preferably, an organic hollow pigment having a percentage of hollowness of 30% or more and a particle diameter of 300 nm or more, the coating layer acts as a heat insulating layer, and heating effect by heating rolls or heat emission apparatuses very efficiently works upon the toners on the transfer paper to accelerate melting or softening of the toners. As a result, the above-mentioned various problems have been solved by the present invention.

The transfer paper for electrophotography according to the first invention is a transfer paper comprising a base paper and at least one coating layer provided on the base paper, characterized in that the uppermost coating layer contains not less than 5 parts by mass of an organic hollow pigment based on 100 parts by mass of pigment in the uppermost coating layer.

In the above invention, by containing organic hollow particles in an amount of not less than 5 parts by mass based on 100 parts by mass of pigment in the uppermost coating layer among the coating layers provided on the base paper, the uppermost coating layer exhibits an effect as a heat insulating layer as mentioned above.

In the present invention, the organic hollow pigment used as the pigment in the coating layer can be obtained by a production method such as, for example, an alkali/acid two-stage treating method. It is preferred that the percentage of hollowness of the hollow pigment is 30% or more and the particle diameter is 300 nm or more. The composition of the hollow pigment is a polymer mainly composed of styrene, and may be a copolymer containing monomers such as acryl and butadiene.

In the present invention, the amount of the organic hollow pigment contained in the coating layer is not less than 5 parts by mass based on 100 parts by mass of total pigment. If it is less than 5 parts by mass, the effect of the present invention given by the organic hollow pigment cannot be obtained.

The base paper used in the above invention may be non-coated paper or coated paper. Internal fillers may or may not be used. Internal fillers usable include, for example, precipitated calcium carbonate and ground calcium carbonate, and, besides, kaolin, clay, talc, titanium dioxide and organic pigments.

As internal sizing agents used for making the base paper of the transfer paper for electrophotography of the present invention, mention may be made of, for example, rosin sizing agents in the case of acidic paper making and alkyl ketene dimers, alkenylsuccinic acid anhydrides, neutral rosin sizing agents and cationic styrene-acryl in the case of neutral paper making.

In the stuffs used for making the base paper of the transfer paper for electrophotography of the present invention, there may be additionally used conventionally used internal aids for paper making, such as yield improving agents, various anionic, nonionic, cationic or amphoteric freeness improving agents and strengthening agents as required so long as they do not damage the desired effects of the present invention. For example, one or more of various starches, polyacrylamide, polyethyleneimine, polyamine, polyamide polyamine, urea-formaldehyde resin, melamine-formaldehyde resin, vegetable gum, polyvinyl alcohol, latex, polyethylene oxide and polyamide resin are used each alone or in optional combination of two or more.

On the surface of the base paper of the transfer paper for electrophotography of the present invention, there may naturally be coated binders such as processed or modified starches, e.g., oxidized starches, etherified starches, esterified starches, cation starches, phosphoric acid starches and phosphoric acid esterified starches, casein and polyvinyl alcohol, surface sizing agents such as styrene/acrylic acid-based copolymers, styrene/methacrylic acid-based copolymers, acrylonitrile/vinylformal/acrylate copolymers and styrene/maleic acid copolymers, dimensional stabilizers such as ethylene-urea resins, inorganic electrically conductive agents such as sodium chloride and potassium chloride, organic electrically conductive agents, surface active agents, pigments and dyes.

As the apparatus for coating the above binders, surface sizing agents, etc., there may be suitably employed conventional size press, gate roll size press, size press of metered film transfer type, rod coater, bill blade, short dwell coater, blade coater, air knife coater, etc. Of these coating apparatuses, preferred are those which can impregnate the inner part of the paper with the size press solution.

Pulps used for making the base paper of the transfer paper for electrophotography of the present invention include, for example, NBKP, LBKP, NBSP, LBSP, GP, TMP, and furthermore non-wood pulps such as kenaf and bagasse and waste paper pulps. These are used each alone or in combination as desired.

As the constituent materials for the waste paper pulps used in the present invention, mention may be made of white shaving paper (johaku), ruled white paper (keihaku), creamy white paper (cream haku), card, special white paper (tokuhaku), medium white paper (chuhaku), flyleaf shaving paper (mozou), fair paper (irohaku), Kent paper, white art paper (shiro art), finest cut paper (tokujogiri), special cut paper (betsujogiri), newspaper, magazine paper, etc. which are shown in the standard table for waste paper standard quality supplied by the Waste Paper Regeneration Acceleration Center Foundation. Specific examples are OA waste papers such as non-coated papers for computer which are information-related papers, printer papers, e.g., heat-sensitive papers and pressure-sensitive papers, and PPC recording papers, and waste papers of papers or boards, e.g., coated papers such as art papers, coated papers, slightly coated papers (bitoko papers), and matte papers, and non-coated papers such as woodfree papers, color woodfree papers, notebook papers, letter papers, packing papers, fancy papers, woodcontaining papers, newspapers, groundwood papers, supercalendered papers, flyleaf shaving papers, pure white machine glazed papers, and milk cartons. These waste papers are chemical pulp papers and high yield pulp-containing papers. These are not particularly limited irrespective of printed papers, copied papers, and non-printed papers.

Other additives include, for example, pH adjustors, sequestering agents, mildew proofing agents, viscosity modifiers, surface tension adjustors, wetting agents, surface active agents and rust preventing agents.

For making the base papers used in the present invention, there may be optionally used known paper machines such as Fourdrinier paper machines, twin-wire paper machines, combination paper machines, cylinder paper machines and Yankee paper machines.

The thickness of the base paper is not particularly limited, and papers of about 50-350 g/m² in basis weight are generally used. The thicker papers are superior to conventional papers in toner fixability and gloss of print portions. Preferred are those of 70-250 g/m² in basis weight.

As pigments which can be used in the coating layers in combination with the organic hollow pigment, mention may be made of white inorganic pigments such as precipitated calcium carbonate, ground calcium carbonate, magnesium carbonate, kaolin, delaminated kaolin, calcined kaolin, talc, calcium sulfate, barium sulfate, titanium dioxide, zinc oxide, zinc sulfide, zinc carbonate, satin white, aluminum silicate, diatomaceous earth, calcium silicate, synthetic amorphous silica, colloidal silica, cation-modified colloidal silica, aluminum hydroxide, alumina, alumina hydrate, lithopone, zeolite, hydrated halloysite and magnesium hydroxide, and organic pigments such as acrylic plastic pigments, polyethylene, microcapsules, urea resin and melamine resin.

As binders used in the coating layers, mention may be made of starch derivatives such as oxidized starch, etherified starch, esterified starch and phosphoric acid esterified starch; cellulose derivatives such as carboxymethyl cellulose and hydroxyethyl cellulose; casein, gelatin, soybean protein, polyvinyl alcohol or derivatives thereof; polyvinyl pyrrolidone, maleic anhydride resin, conjugated diene copolymer latexes such as styrene-butadiene copolymer and methyl methacrylate-butadiene copolymer; acrylic polymer latexes such as polymers or copolymers of acrylate esters and methacrylate esters; vinyl polymer latexes such as ethylene-vinyl acetate copolymer; functional group-modified polymer latexes of the above-mentioned polymers which are modified with monomers containing functional groups such as carboxyl group; or the above-mentioned polymers which are cationized with cationic groups, the above-mentioned polymers, the surface of which is cationized with a cationic surface active agent, the above-mentioned polymers obtained by polymerization in the presence of cationic polyvinyl alcohol to distribute the polyvinyl alcohol on the surface of the polymers, and the above-mentioned polymers obtained by polymerization in a suspension of cationic colloid particles to distribute the particles on the surface of the polymers; aqueous adhesives such as thermosetting synthetic resins, e.g., melamine resin and urea resin; polymer or copolymer resins of acrylate esters or methacrylate esters such as polymethyl methacrylate; synthetic resin adhesives such as polyurethane resins, unsaturated polyester resins, vinyl chloride-vinyl acetate copolymers, polyvinyl butyral and alkyd resins.

The above binders can be used each alone or in combination of two or more, and can be used in an amount of 3-70 parts by mass, preferably 5-50 parts by mass in total based on 100 parts by mass of the pigment. If the amount of the binder is less than 3 parts by mass, the strength of the coating layer is insufficient, and if it is more than 70 parts by mass, the fixability of toners are sometimes deteriorated. Furthermore, the coating layer may further contain other additives such as pigment dispersant, thickening agent, fluidity improving agent, anti-foaming agent, foam-inhibitor, releasing agent, foaming agent, penetrant, colored dye, colored pigment, fluorescent brightening agent, ultraviolet absorber, antioxidant, preservative, antifungal agent, water resisting agent, dye fixer, and inorganic and organic conductive agent.

The transfer paper for electrophotography of the second invention is characterized in that it comprises a support comprising a base paper coated with a resin having film-forming ability on both sides and at least one coating layer provided on the side of the support to be printed, and the uppermost coating layer contains not less than 5 parts by mass of an organic hollow pigment based on 100 parts by mass of pigment in the uppermost coating layer.

That is, in the transfer paper for electrophotography of the second invention, a resin-coated paper (RC paper) having high gloss, high smoothness and high image formability which is obtained by coating one or both sides of a paper or coated paper with a polyolefin resin is used as a support. As the resin used here, preferred are thermoplastic resins such as polyolefin resins, polycarbonate resins, polyester resins and polyamide resins, and more preferred are polyolefin resins from the point of melt extrusion coatability.

In the above invention, the surface of the base paper is coated with a resin to give high gloss, high smoothness and high image formability. Therefore, by further providing the coating layer according to the present invention, the higher toner fixability and the higher gloss of images after printing can be obtained.

The polyolefin resins can be selected from α-olefin homopolymers such as polyethylene and polypropylene, copolymers of α-olefins and mixtures of these polymers. Especially preferred polyolefin resins are polyethylene resins, and the polyethylene resins include low-density polyethylene, medium-density polyethylene, high-density polyethylene, straight-chain low-density polyethylene and mixtures thereof, and those having various densities, melt flow rates (hereinafter referred to as merely “MFR”), molecular weights and molecular weight distributions can be used. Usually, those which have a density of 0.90-0.97 g/cm³ and an MFR of 0.1-50 g/10 min, preferably 0.3-40 g/10 min can be advantageously used each alone or in admixture. Furthermore, when the resin has a multilayer structure, resins of different properties and constructions can be used, for example, a resin having an MFR of 5-20 g/10 min can be used as the uppermost layer and a resin having an MFR of 2-10 g/10 min can be used as a lower layer.

The thickness of the polyolefin resin layer is suitably 4-70 μm, and preferably 6-45 μm, especially preferably 10-40 μm.

The polyolefin resin layer can contain titanium dioxide pigment coated with an organic material as mentioned above. The titanium dioxide pigment can be contained in the polyethylene resin to be coated on the base paper in the following manner. That is, a so-called master batch is prepared by previously containing the titanium dioxide pigment in a polyethylene resin at a desired concentration and the master batch is diluted to a desired concentration by mixing with a polyethylene resin for dilution, or a so-called compound is prepared by containing the titanium dioxide pigment in a polyethylene resin at a desired compositional ratio. The master batch or compound can be prepared by using a Banbury mixer, a kneader, an extruder for kneading, a roll kneader, or the like. Two or more of these kneading machines can be used in combination.

The polyolefin resin used for preparing a polyolefin resin composition of the master batch or compound comprising the titanium dioxide pigment and the polyolefin resin is preferably one which has properties suitable for kneading of titanium dioxide pigment and polyolefin resin. Specifically, preferred is a low-density polyethylene resin having a density of 0.917-0.925 g/cm³ and an MFR of 3-12 g/10 min or a medium-density polyethylene resin.

It is preferred to prepare the polyolefin resin composition comprising titanium dioxide pigment and polyolefin resin in the presence of a suitable amount of an antioxidant. Specifically, it is preferred to use a suitable amount of a hindered phenol antioxidant mentioned or exemplified in JP-A-1-105245, a phosphorus antioxidant mentioned or exemplified in JP-A-55-142335, and other various antioxidants such as hindered amine antioxidants and sulfur antioxidants, and it is especially preferred to allow a suitable amount of the hindered phenol antioxidant to be present. The amount of these antioxidants present during preparation of the polyolefin resin composition is preferably 50-3000 ppm, more preferably 50-200 ppm.

It is preferred to prepare the polyolefin resin composition comprising titanium dioxide pigment and polyolefin resin in the presence of a proper amount of a suitable lubricant. Preferred examples of the lubricant are fatty acid metal salts such as zinc stearate, calcium stearate, aluminum stearate, magnesium stearate, zinc palmitate and calcium palmitate, and use of one or both of zinc stearate and magnesium stearate is especially preferred. The amount of the lubricant used is usually 0.1-20% by mass, preferably 0.1-7.5% by mass based on the titanium dioxide pigment.

The polyolefin resin may contain various other additives in addition to the titanium dioxide pigment, fatty acid metal salt and antioxidant. There may be used, in an optional combination, various additives, e.g., white pigments such as zinc oxide, talc and calcium carbonate, fatty acid amides such as stearic acid amide and arachidic acid amide, blue pigments or dyes such as cobalt blue, ultramaline, cerulean blue and phthalocyanine blue, magenta pigments or dyes such as cobalt violet, fast violet and manganese violet, fluorescent brightening agents and ultraviolet absorbers mentioned or exemplified in JP-A-2-254440. These additives are contained preferably as a master batch or compound of the resin.

Coating of the polyolefin resin is preferably carried out by a so-called melt extrusion coating method which comprises casting the resin composition in the form of a film on a running base paper from a slit die of a melt extrusion machine. In this case, the temperature of the molten film is preferably 270-330° C.

The slit die is preferably a flat die such as T-die, L-die or fish-tail die, and the slit aperture diameter is preferably 0.1-2 mm. Preferably, the base paper is subjected to an activation treatment such as corona discharge treatment or flame treatment before coating the resin composition on the base paper. Furthermore, it is also possible to coat the resin layer on a running base paper after spraying an ozone-containing gas to the molten resin composition contacting with the base paper as disclosed in JP-B-61-42254. The resin layers on the surface side and the back side can be coated on the base paper by a so-called co-extrusion coating process comprising simultaneously extruding two or more layers or a so-called tandem extrusion coating process comprising consecutively or continuously extrusion coating the resin layers. In this case, the coating can be carried out at a high speed without causing occurrence of stepwise unevenness in cross direction or formation of satin surface.

Furthermore, the surface of the polyolefin resin layer can be subjected to an activation treatment such as corona discharge treatment or flame treatment. Moreover, after the activation treatment, an undercoating treatment as mentioned or exemplified in JP-A-1-102551 or JP-A-1-166035 can be carried out. The undercoating layer is mainly composed of gelatin, and, if necessary, may further contain additives such as hardening agent, surface active agent, thickening agent, white pigment, matting agent, anti-foaming agent, antistatic agent and antifoggant. Moreover, white pigments usable in the undercoating layer include, for example, titanium dioxide, barium sulfate, calcium sulfate, barium carbonate, calcium carbonate, alumina white, zinc oxide, silica white, antimony trioxide and titanium phosphate.

The undercoating layer can be provided on the surface of the polyolefin layer by air knife coater, roll coater, bar coater, wire bar coater, blade coater, slide hopper coater, curtain coater, gravure coater, flexo gravure coater, and combination of them. Preferably, the resin surface is subjected to an activation treatment such as corona discharge treatment or flame treatment prior to the coating. As the drying apparatus for drying the coated solution, mention may be made of various drying apparatuses, e.g., hot-air dryers such as linear tunnel dryers, arch dryers, air loop dryers and sine curve air float dryers, and infrared heating dryers, and dryers utilizing microwaves. The drying conditions may be optional, and the drying is generally carried out at 60-150° C. for several seconds to 10 minutes.

The transfer paper for electrophotography of the third invention is a transfer paper comprising a base paper and at least one coating layer provided thereon, characterized in that the uppermost coating layer contains not less than 5 parts by mass of an organic hollow pigment based on 100 parts by mass of pigment in the uppermost coating layer and the coating layer has a gloss given by cast treatment.

That is, in the third invention, not less than 5 parts by mass of an organic hollow pigment based on 100 parts by mass of pigment is contained in the uppermost coating layer among the coating layers provided on the base paper and then the coating layer is subjected to a cast treatment to obtain a transfer paper for electrophotography which is excellent in gloss of printed images and has a paper gloss and a gloss of image portions which are close to those of a photograph obtained using a photographic paper.

In the above invention, the transfer paper is produced by subjecting the coating layer to cast treatment and gloss finishing. The coating amount varies depending on properties of the base paper and production method and is usually about 2-50 g/m², and one or both sides of the base paper are coated.

As the method of cast treatment, there are direct method, gelling method and rewetting method. Among them, the direct method comprises pressing the coating layer coated on the support which is still in wet state to a heated specular drum surface to perform glazed finishing. The gelling method comprises contacting the coating layer coated on the support which is still in wet state with a gelling bath or heating the coating layer in wet state, thereby to allow the coating layer to be in wet gelling state and pressing this coating layer to a heated specular drum surface to perform glazed finishing. The rewetting method comprises once drying the coating layer in wet state, then contacting this coating layer with a rewetting solution, and thereafter pressing the coating layer in wet state to a heated specular drum surface to perform glazed finishing.

The method of cast treatment of the coating layer may be any of the above methods, but the object of the present invention can be more sufficiently attained when the paper gloss of the gloss layer is 80% or more in terms of 75° specular gloss in accordance with JIS P-8142.

In carrying out the cast coating, a releasing agent and a water resisting agent are important as assistants. As the releasing agent, there may be suitably used stearic acid, calcium stearate, oleic acid, calcium oleate, ammonium oleate, lecithin, polyethylene, wax or derivatives thereof. As the water resisting agent for casein, soybean protein and starch which are hydrophilic adhesives, there are formalin, glyoxal, zinc oxide, epoxy compounds, zirconium carbonate, alkyl ketene dimers, etc. Furthermore, there is a method of water resisting the surface of the coating layer by irradiation with ultraviolet rays or electron rays, corona discharging, or the like after releasing from the cast drum.

The method for providing the coating layer is not particularly limited, and there may be used conventional size press, gate roll size press, metered film transfer type size press, roll coater, gravure coater, rod coater, bill blade coater, short dwell coater, blade coater, air knife coater, curtain coater, cast coater, spray coater, etc. The coating amount of the heat insulating layer is preferably 2-50 g/m². The coating layer intended to act as the heat insulating layer is preferably the uppermost layer, but can be an intermediate layer or an undercoating layer. The method for surface treatment of the coating layer is also not particularly limited, and super calender, soft nip calender, multi-stage soft nip calender, machine calender, rewet cast and the like can be optionally used.

The transfer papers for electrophotography of the present invention can be used not only as transfer papers for electrophotography used in outputting devices such as copiers, printers, on-demand printers, and facsimile machines, but also as wet electrophotographic printing papers, offset printing papers and heat transfer image receiving papers. Furthermore, they can be used as labels with coating an adhesive layer on the side opposite to the printing side.

### EXAMPLES

The present invention will be explained by the following examples, which should not be construed as limiting the invention in any manner. All “part” and “%” in the examples are “part by mass” and “% by mass”, respectively, unless otherwise notified.

[The First and Second Inventions]

<Preparation of Base Paper>

| | | |
|---|---|---|
| LBKP (freeness: 440 mlcsf) | 70 | parts |
| NBKP (freeness: 490 mlcsf) | 30 | parts |
| Precipitated calcium carbonate (*ash | *9 | parts |
| content in body paper) | | |
| Commercially available cationized starch | 0.7 | part |
| Commercially available cationic polyacrylamide | 0.03 | part |
| yield improver | | |

The pulps and internal chemicals of the above formulation were prepared, and a base paper A of 100 g/m² in basis weight and a base paper B of 220 g/m² in basis weight were made from the resulting preparation.

<Formulation of Coating Color>

| | | |
|---|---|---|
| Pigment (shown in the following Table 1) | 100 | parts |
| Commercially available polyacrylic | 0.1 | part |
| acid dispersant | | |
| Commercially available binder (SBR | 18 | parts |
| latex) | | |
| Commercially available phosphoric | 4 | parts |
| acid esterified starch | | |
| Commercially available carboxymethyl | 0.1 | part |
| cellulose thickening agent (CMC) | | |
| Commercially available lubricant (calcium | 2 | parts |
| stearate) | | |

The pH of this coating color was adjusted to 9.6 with sodium hydroxide.

TABLE 1

| | Organic hollow | | | |
|---|---|---|---|---|
| | particle (X) | | | |
| | Percentage | | | |
| | of | Particle | | |
| | hollowness | diameter | Inorganic pigment | Amount |
| Formulation | (%) | (nm) | (Y) | (X/Y) |
| A | 50 | 1000 | Kaolin/precipitated | 5/(50/45) |
| | | | calcium carbonate | |
| B | ″ | ″ | Kaolin | 50/50 |
| C | ″ | ″ | ″ | 100/0 |
| D | ″ | ″ | Ground calcium | 10/90 |
| | | | carbonate | |
| E | 55 | ″ | Kaolin | 50/50 |
| F | 35 | ″ | ″ | 50/50 |
| G | 50 | 400 | ″ | 50/50 |
| H | 0 | 200 | ″ | 50/50 |
| I | — | — | ″ | 0/100 |
| J | — | — | Ground calcium | 0/100 |
| | | | carbonate | |
| K | — | — | Precipitated | 0/100 |
| | | | calcium carbonate | |
| L | 50 | 1000 | Kaolin | 4/96 |
| M | 50 | 1000 | ″ | 2/98 |

### Example 1

The coating color of the formulation A was coated on both sides of the base paper A in a coating amount of 15 g/m² per one side by a blade coater, followed by drying and then supercalendering to obtain a transfer paper for electrophotography of Example 1.

### Example 2

A transfer paper for electrophotography of Example 2 was obtained in the same manner as in Example 1, except that the coating color of the formulation B was used.

### Example 3

A transfer paper for electrophotography of Example 3 was obtained in the same manner as in Example 1, except that the coating color of the formulation C was used.

### Example 4

A transfer paper for electrophotography of Example 4 was obtained in the same manner as in Example 1, except that the coating color of the formulation D was used.

### Example 5

A transfer paper for electrophotography of Example 5 was obtained in the same manner as in Example 1, except that the coating color of the formulation E was used.

### Example 6

A transfer paper for electrophotography of Example 6 was obtained in the same manner as in Example 1, except that the coating color of the formulation F was used.

### Example 7

A transfer paper for electrophotography of Example 7 was obtained in the same manner as in Example 1, except that the coating color of the formulation G was used.

### Comparative Example 1

A transfer paper for electrophotography of Comparative Example 1 was obtained in the same manner as in Example 1, except that the coating color of the formulation H was used.

### Comparative Example 2

A transfer paper for electrophotography of Comparative Example 2 was obtained in the same manner as in Example 1, except that the coating color of the formulation I was used.

### Comparative Example 3

A transfer paper for electrophotography of Comparative Example 3 was obtained in the same manner as in Example 1, except that the coating color of the formulation J was used.

### Comparative Example 4

A transfer paper for electrophotography of Comparative Example 4 was obtained in the same manner as in Example 1, except that the coating color of the formulation K was used.

### Comparative Example 5

A transfer paper for electrophotography of Comparative Example 5 was obtained in the same manner as in Example 1, except that the coating color of the formulation L was used.

### Comparative Example 6

A transfer paper for electrophotography of Comparative Example 6 was obtained in the same manner as in Example 1, except that the coating color of the formulation M was used in Example 1.

### Example 8

A transfer paper for electrophotography of Example 8 was obtained in the same manner as in Example 2, except that the base paper B was used as the base paper.

### Comparative Example 7

A transfer paper for electrophotography of Comparative Example 7 was obtained in the same manner as in Comparative Example 2, except that the base paper B was used as the base paper.

### Example 9

A transfer paper for electrophotography of Example 9 was obtained in the same manner as in Example 2, except that the finishing treatment was carried out by a soft nip calender.

### Example 10

The following coating color was coated on one side of the base paper A in a coating amount of 15 g/m² by the direct method using a cast coater to obtain a transfer paper for electrophotography of Example 10.

<Formulation of Coating Color>

| | | |
|---|---|---|
| Organic hollow pigment (HP91 manufactured | 50 | parts |
| by Nippon Zeon Co., Ltd.) | | |
| Kaolin (DB PRIME manufactured by | 50 | parts |
| Dry Branch Kaolin Co., Ltd.) | | |
| Commercially available polyacrylic | 0.1 | part |
| acid dispersant | | |
| Binder (SBR latex) | 25 | parts |
| Casein | 10 | parts |
| Commercially available releasing | 8 | parts |
| agent (oleic acid derivative) | | |

### Example 11

A pulp mixture comprising 50% of a hardwood bleached kraft pulp, 35% of a hardwood bleached sulfite pulp and 15% of a softwood bleached sulfite pulp was beaten to a freeness (CSF) of 350 ml. Then, to 100 parts of the pulp were added 3 parts of cationized starch, 0.2 part of anionized polyacrylamide, 0.4 part of alkyl ketene dimer emulsion (as ketene dimer content), 0.4 part of polyamide-epichlorohydrin resin, and suitable amounts of a fluorescent brightening agent, a blue dye and a red dye, thereby to prepare a pulp slurry.

Thereafter, the resulting pulp slurry was put on a Fourdrinier paper machine running at 200 m/min and a web was formed while giving a suitable turbulence, and then the web was subjected to three-stage wet press which was adjusted in linear pressure within the range of 15-100 kg/cm in the wet part, treated by a smoothing roll, subjected to two-stage machine calendering which was adjusted in linear pressure within the range of 30-70 kg/cm in the subsequent drying part, and then dried.

Then, during the drying, the web was subjected to size press with 25 g/m² of a size press solution comprising 4 parts of carboxy-modified polyvinyl alcohol, 0.05 part of a fluorescent brightening agent, 0.002 part of a blue dye, 4 parts of sodium chloride and 92 parts of water, followed by drying so that water content of the finally obtained base paper reached 8% in absolute dry water content and then machine calendering under a linear pressure of 50 kg/cm to produce a base paper for photographic support having a basis weight of 170 g/m².

Then, the side (back side) of the base paper opposite to the side to be provided with a photographic constituent layer was subjected to corona discharge treatment and thereon was melt extrusion coated with a compound resin composition comprising 35 parts of a low-density polyethylene resin (density: 0.92 g/cm³, MFR: 2 g/10 min) and 65 parts of a high-density polyethylene resin (density: 0.96 g/cm³, MFR: 20 g/10 min) at a thickness of 25 μm and at a resin temperature of 310° C.

Successively, the surface side of the base paper was subjected to corona discharge treatment and thereon was melt extrusion coated with a resin composition comprising 20 parts of a master batch of titanium dioxide pigment comprising 47.5% of a low-density polyethylene resin (density: 0.92 g/cm³, MFR: 8.5 g/10 min), 50% of an anatase type titanium dioxide pigment surface-treated with a hydrous aluminum oxide (0.75% as Al₂O₃ content based on titanium dioxide) and 2.5% of zinc stearate, 65 parts of a low-density polyethylene resin (density: 0.92 g/cm³, MFR: 4.5 g/10 min) and 15 parts of a high-density polyethylene resin (density: 0.97 g/cm³, MFR: 7.0 g/10 min) at a thickness of 30 μm under the conditions of a processing speed of 250 m/min and a temperature of 310° C., and finally an undercoating layer mainly composed of gelatin was coated to obtain a support.

The coating color of the formulation B was coated on one side of the resulting support in a coating amount of 12 g/m² per one side by a rod coater and then dried. Then, soft nip calendering was carried out to obtain a transfer paper for electrophotography of Example 11.

Paper gloss, toner fixability (rubbing, peeling with tape) and gloss of the image portion of the transfer papers for electrophotography obtained in Examples 1-11 and Comparative Examples 1-7 were measured by the following methods. The results are shown in Table 2.

1) Paper Gloss

A sample was subjected to moisture conditioning for 24 hours in an environment of 20° C. and 65% RH and then the 750 specular gloss of the sample was measured in accordance with JIS P-8142 to obtain a paper gloss.

2) Toner Fixability (Peeling with Tape)

On a paper sample of A4 size longer in machine direction was printed the TEST CHART TYPE 1 of the Printing Society by transversely passing the sample through LP-8300C printer (manufactured by Epson Co., Ltd.) at a mode for plain paper. An adhesive cellophane tape (CELLOTAPE R No. 405 manufactured by Nichiban Co., Ltd.) of 18 mm in width was applied to the sample in such a manner that no uneven application occurred on the image portions of various colors, and the tape was slowly peeled at an angle of 180° at a speed of about 5 mm/sec. The degree of fixation of toners onto the paper after peeling of the tape was visually examined and evaluated at 6 grades according to the following criteria. Practically acceptable level was (4) or more.

(6): Most of the toners of all colors remained on the paper.

(5): Although the toners of all colors remained on the paper, print density of the image portions after peeling of the tape lowered.

(4): The toners of some colors were removed from the paper, and there were white voids in the image portions.

(3): The toners of all colors were removed from the paper, and there were white voids in the image portions.

(2): The toners of all colors were removed from the paper, and a few toners remained on the paper.

(1): The toners of all colors were removed from the paper, and no image portions remained.

3) Toner Fixability (Rubbing)

The rubbing evaluation was conducted by using the horizontal method of “Friction coefficient test method of paper and board” specified in JIS P8147. A blank transfer paper for electrophotography obtained in each of the examples and comparative examples was stuck to the horizontal plate and the transfer paper for electrophotography having print portions printed by the above printer was stuck to the weight. The transfer paper for electrophotography having print portions was stuck to the weight in such a manner that the printed surface of the print portion was rubbed with the blank transfer paper stuck to the horizontal plate. After the test pieces were stuck to the horizontal plate and the weight in this way, the weight was slid on the horizontal plate under the conditions described in JIS P8147. In “friction test”, the weight is slid only one time on the horizontal plate in combination with one test piece while in this evaluation test the weight was slid 50 times on the horizontal plate in combination with one test piece. Then, the print portion stuck to the weight was observed and the degree of falling off of the toners caused by rubbing of papers each other was observed. The degree of retention of the toners on the print portion was visually examined and evaluated at 4 grades according to the following criteria. The grades “∘” and “⊚” were of the present invention.

⊚: The density of the print portion hardly decreased for all colors.

◯: The density of the print portion slightly decreased for all colors.

Δ: The density of the print portion decreased for all colors.

X: The density of the print portion decreased for all colors, and there were white void portions.

4) Gloss of Image Portion

On the paper sample of A4 size longer in machine direction was printed the TEST CHART TYPE 1 of the Printing Society by transversely passing the sample through LP-8300C printer (manufactured by Epson Co., Ltd.) at a mode for plain paper. This sample was irradiated with an oblique light, and the gloss was visually evaluated by four grades (⊚: Usable with no problem; ◯: Practically usable; Δ: Practically unusable; X: Unusable) based on the degree of closeness to photographs prepared using photographic papers.

TABLE 2

| Example or | | Gloss of | Toner fixability | |
|---|---|---|---|---|
| Comparative | White paper | image | Peeling | |
| Example | gloss | portion | with tape | Rubbing |
| Example 1 | 66 | ◯ | 4 | ◯ |
| Example 2 | 72 | ◯ | 6 | ⊚ |
| Example 3 | 80 | ◯ | 6 | ⊚ |
| Example 4 | 49 | ◯ | 6 | ⊚ |
| Example 5 | 82 | ◯ | 6 | ⊚ |
| Example 6 | 63 | ◯ | 4 | ◯ |
| Example 7 | 62 | ◯ | 4 | ◯ |
| Comparative | 45 | Δ | 3 | Δ |
| Example 1 | | | | |
| Comparative | 60 | X | 2 | X |
| Example 2 | | | | |
| Comparative | 40 | X | 2 | X |
| Example 3 | | | | |
| Comparative | 41 | X | 2 | X |
| Example 4 | | | | |
| Comparative | 64 | Δ | 4 | Δ |
| Example 5 | | | | |
| Comparative | 62 | Δ | 4 | Δ |
| Example 6 | | | | |
| Example 8 | 72 | ◯ | 5 | ◯ |
| Comparative | 59 | X | 1 | X |
| Example 7 | | | | |
| Example 9 | 75 | ◯ | 6 | ⊚ |
| Example 10 | 91 | ◯ | 6 | ⊚ |
| Example 11 | 85 | ⊚ | 5 | ◯ |

It can be seen from Table 2 that toner fixability and gloss of print portion in Examples 1-7 where the coating layer contained the organic hollow pigment having the specified percentage of hollowness and particle diameter were superior to those in Comparative Example 1 where the percentage of hollowness and particle diameter of the organic hollow pigment were not proper, those in Comparative Examples 2-4 where the organic hollow pigment was not contained and those in Comparative Examples 5 and 6 where the content of the organic hollow pigment was smaller. Example 8 and Comparative Example 7 compared the gloss and fixability in the case of using a thick paper which was severer in conditions, and the toner fixability and gloss of image portion in Example 8 were not damaged due to the effect of the heat insulating layer. In Examples 9 and 10 where the base papers were produced by soft nip calendering and cast coating, though there was a difference in white paper gloss caused by difference in finishing method, the toner fixability and gloss of image portion were clearly superior to those of the Comparative Examples. Furthermore, in Example 11 where a heat insulating layer was provided on an RC paper, good toner fixability and especially excellent gloss of image portion were obtained.

[The Third Invention]

<Preparation of Base Paper>

| | | |
|---|---|---|
| LBKP (freeness: 440 mlcsf) | 70 | parts |
| NBKP (freeness: 490 mlcsf) | 30 | parts |
| Precipitated calcium carbonate (*ash | *8 | parts |
| content in body paper) | | |
| Commercially available cationized starch | 0.8 | part |
| Commercially available cationic polyacrylamide | 0.03 | part |
| yield improver | | |

The pulps and internal chemicals of the above formulation were prepared, and a base paper of 190 g/m² in basis weight was prepared the resulting preparation.

<Formulation of Coating Color>

| | | |
|---|---|---|
| Pigment (shown in the following Table 3) | 100 | parts |
| Commercially available polyacrylic | 0.1 | part |
| acid dispersant | | |
| Binder (SBR latex) | 25 | parts |
| Phosphoric acid esterified starch | 10 | parts |
| Releasing agent (calcium stearate) | 2 | parts |

The formulations of the pigments are shown in the following Table 3. The pigments used are as follows.

Organic hollow pigment: HP91 manufactured by Nippon Zeon Co., Ltd.

Kaolin: DB PRIME manufactured by Dry Branch Kaolin Co., Ltd.

Ground calcium carbonate: CARBITAL 90 manufactured by ECC International Co., Ltd.

Precipitated calcium carbonate: BRILLIANT 15 manufactured by Shiraishi Calcium Co. Ltd.

TABLE 3

Amount
(part by mass)

| | | Organic | |
|---|---|---|---|
| | Combination of | hollow | Other |
| Formulation | pigments | pigment | pigment |
| N | Organic hollow | 5 | 95 |
| | pigment/Kaolin | | |
| O | Organic hollow | 50 | 50 |
| | pigment/Kaolin | | |
| P | Organic hollow | 100 | 0 |
| | pigment/— | | |
| Q | Organic hollow | 3 | 97 |
| | pigment/Kaolin | | |
| R | —/Kaolin | 0 | 100 |
| S | —/ground calcium | 0 | 100 |
| | carbonate | | |
| T | —/precipitated | 0 | 100 |
| | calcium carbonate | | |
| U | Organic hollow | 50 | 50 |
| | pigment/heavy | | |
| | calcium carbonate | | |
| V | Organic hollow | 50 | 50 |
| | pigment/precipitated | | |
| | calcium carbonate | | |

### Example 12

The coating color of the formulation N was coated on the base paper by a roll applicator and pressed to a casting drum and dried (direct casting method), thereby to produce a transfer paper for electrophotography of Example 12 having a coating amount of 15 g/m² per one side.

### Example 13

A transfer paper for electrophotography of Example 13 was obtained in the same manner as in Example 12, except that the coating color of the formulation 0 was used.

### Example 14

A transfer paper for electrophotography of Example 14 was obtained in the same manner as in Example 12, except that the coating color of the formulation P was used.

### Comparative Example 8

A transfer paper for electrophotography of Comparative Example 8 was obtained in the same manner as in Example 12, except that the coating color of the formulation Q was used.

### Comparative Example 9

A transfer paper for electrophotography of Comparative Example 9 was obtained in the same manner as in Example 12, except that the coating color of the formulation R was used.

### Comparative Example 10

A transfer paper for electrophotography of Comparative Example 10 was obtained in the same manner as in Example 12, except that the coating color of the formulation S was used.

### Comparative Example 11

A transfer paper for electrophotography of Comparative Example 11 was obtained in the same manner as in Example 12, except that the coating color of the formulation T was used.

### Example 15

A transfer paper for electrophotography of Example 15 was obtained in the same manner as in Example 12, except that the coating color of the formulation U was used.

### Example 16

A transfer paper for electrophotography of Example 16 was obtained in the same manner as in Example 12, except that the coating color of the formulation V was used.

### Example 17

The coating color of the formulation obtained by changing the phosphoric acid esterified starch in the coating solution of the formulation 0 to 10 parts of casein (+1.2 parts of dicyandiamide, 1.2 parts of ammonium nitrate and 0.1 part of sodium hydroxide) was coated on the base paper in a coating amount of 15 g/m² (solid content) by a roll coater, and this was passed through a calcium chloride coagulation solution to coagulate the coat by the salt gelling method, followed by pressing the coat to a casting drum and drying to carry out the salt coagulation process casting treatment, thereby to obtain a transfer paper for electrophotography of Example 17.

### Example 18

A solution prepared by adding calcium chloride in an amount of 0.007 part by mass based on 100 parts by mass of the pigment to the coating solution of the formulation of Example 17 was coated on the base paper in a coating amount of 15 g/m² (solid content) by a roll coater, coagulated by an infrared dryer, pressed to a casting drum and dried to carry out the heat coagulation process casting treatment, thereby to obtain a transfer paper for electrophotography of Example 18.

Paper gloss, toner fixability (peeling with tape, rubbing) and gloss of image portion of the transfer papers for electrophotography of Examples 12-18 and Comparative Examples 8-11 were measured by the above-mentioned methods, and the results are shown in Table 4.

TABLE 4

| Example or | | Gloss of | Toner fixability | |
|---|---|---|---|---|
| Comparative | | image | Peeling | |
| Example | Paper gloss | portion | with tape | Rubbing |
| Example 12 | 78.2 | ◯ | 5 | ◯ |
| Example 13 | 85.5 | ⊚ | 6 | ⊚ |
| Example 14 | 102.9 | ⊚ | 6 | ⊚ |
| Comparative | 75.6 | Δ | 4 | Δ |
| Example 8 | | | | |
| Comparative | 76.3 | X | 2 | X |
| Example 9 | | | | |
| Comparative | 73.7 | X | 2 | X |
| Example 10 | | | | |
| Comparative | 74.1 | X | 2 | X |
| Example 11 | | | | |
| Example 15 | 87.2 | ⊚ | 6 | ⊚ |
| Example 16 | 86.5 | ⊚ | 6 | ⊚ |
| Example 17 | 88.7 | ⊚ | 6 | ⊚ |
| Example 18 | 87.2 | ⊚ | 6 | ⊚ |

It can be seen from Table 4 that the toner fixability and the gloss (white paper gloss and gloss of print portion) in Examples 12-14 where the coating layer contained the organic hollow pigment were superior to those in Comparative Examples 9-11 where the coating layer did not contain the organic hollow pigment and those in Comparative Example 8 where the content of the organic hollow pigment was smaller. It can be seen that Examples 15 and 16 showed the similar superiority to Comparative Examples 9-11. Furthermore, the difference depending on the method of casting treatment was little between Example 13 and Examples 17 and 18. Moreover, as can be seen from comparison of Examples 12, 13 and 14, the transfer papers of Examples 13 and 14 where paper gloss was 80% or higher were especially excellent in the gloss of image portion.

### EFFECTS OF THE INVENTION

As explained above, the transfer paper for electrophotography of the present invention can be printed by electrophotographic printers, facsimile, copiers and on-demand printers, has excellent toner fixability and is excellent in gloss of printed images, and can provide images close to those formed on photographic papers in gloss of white papers and gloss of printed image portions.

### INDUSTRIAL APPLICABILITY

The present invention has a great industrial applicability since it provides transfer papers for electrophotography of the present invention which can be printed by electrophotographic printers, facsimile, copying machines and on-demand printers, have excellent toner fixability and are excellent in gloss of printed images, and can provide images close to those formed on photographic papers in gloss of white papers and gloss of printed image portions.

1. A transfer paper for electrophotography comprising a base paper and at least one coating layer provided thereon, characterized in that the uppermost coating layer contains 5-50 parts by mass of an organic hollow pigment having a percentage of hollowness of not less than 30% based on 100 parts by mass of pigment in the uppermost coating layer.

2. A transfer paper for electrophotography, characterized in that it comprises a support comprising a base paper coated with a resin having film-forming ability on both sides and at least one coating layer provided on the side of the support corresponding to the side to be printed, and the uppermost coating layer contains 5-50 parts by mass of an organic hollow pigment having a percentage of hollowness of not less than 30% based on 100 parts by mass of pigment in the uppermost coating layer.

3. A transfer paper for electrophotography comprising a base paper and at least one coating layer provided thereon, characterized in that the uppermost coating layer contains 5-50 parts by mass of an organic hollow pigment having a percentage of hollowness of not less than 30% based on 100 parts by mass of pigment in the uppermost coating layer and the coating layer has a gloss given by casting treatment.

4. A transfer paper for electrophotography according to claim 3 which has a paper gloss of not less than 80% in terms of 75° specular gloss in accordance with JIS P-8142.

5. A transfer paper for electrophotography according to claim 4, wherein the organic hollow pigment has a particle diameter of not less than 300 nm.

6. A transfer paper for electrophotography according to claim 5, which has a basis weight of not less than 140 g/m².

7. A transfer paper for electrophotography according to claim 1, wherein the organic hollow pigment has a particle diameter of not less than 300 nm.

8. A transfer paper for electrophotography according to claim 7, which has a basis weight of not less than 140 g/m².

9. A transfer paper for electrophotography according to claim 2, wherein the organic hollow pigment has a particle diameter of not less than 300 nm.

10. A transfer paper for electrophotography according to claim 9, which has a basis weight of not less than 140 g/m².

11. A transfer paper for electrophotography according to claim 3, wherein the organic hollow pigment has a particle diameter of not less than 300 nm.

12. A transfer paper for electrophotography according to claim 11, which has a basis weight of not less than 140 g/m².

13. A transfer paper for electrophotography according to claim 1, which has a basis weight of not less than 140 g/m².

14. A transfer paper for electrophotography according to claim 2, which has a basis weight of not less than 140 g/m².

15. A transfer paper for electrophotography according to claim 3, which has a basis weight of not less than 140 g/m².

16. A transfer paper for electrophotography according to claim 4, which has a basis weight of not less than 140 g/m².
